(19) United States
(12) Patent Application Publication
(10) Pub. No.: US 2026/0120206 A1
(43) Pub. Date: Apr. 30, 2026

(54) HOME ENERGY MANAGEMENT SYSTEM AND BIDIRECTIONAL REAL-TIMEPRICE PREDICTION METHOD FOR DEMAND RESPONSE

(71) Applicant: CHUNG ANG UNIVERSITY INDUSTRY ACADEMIC COOPERATION FOUNDATION, Seoul (KR)

(72) Inventors: Mun Kyeom KIM, Seoul (KR); Hyung Joon KIM, Seoul (KR)

(21) Appl. No.: 19/181,305

(22) Filed: Apr. 16, 2025

Related U.S. Application Data
(63) Continuation of application No. PCT/KR2025/002728, filed on Feb. 27, 2025.

(30) Foreign Application Priority Data
Oct. 31, 2024 (KR) 10-2024-0152524

(51) Int. Cl. G06Q 50/06; G06Q 10/04; H02J 3/00

(52) U.S. Cl. CPC G06Q 50/06; G06Q 10/04; H02J 3/003; H02J 2103/30; H02J 2105/12

(57) ABSTRACT

A bidirectional real-time price prediction method for demand response comprises (a) acquiring user-related information and real-time electricity price data for a smart home user; (b) generating future electricity price prediction information by applying the user-related information and the real-time electricity price to a deep learning-based prediction model; (c) generating power consumption scheduling results for smart home devices based on the electricity price prediction information; (d) analyzing the power consumption scheduling results to calculate the hourly shifted power and the flexible appliance consumption ratio, and calculating a mobility adjustment value and a consumption adjustment value based on the hourly shifted power and the flexible appliance consumption ratio, respectively; (e) calculating an incentive-penalty weight value according to the power consumption pattern using the mobility adjustment value and the consumption adjustment value; and (f) reflecting the incentive-penalty weight value in the electricity price prediction information to derive the bidirectional real-time electricity price.

### CROSS-REFERENCE TO RELATED APPLICATION

This application is a bypass continuation of pending PCT International Application No. PCT/KR2025/002728, which was filed on Feb. 27, 2025, and which claims priority to Korean Patent Application No. 10-2024-0152524, which was filed in the Korean Intellectual Property Office on Oct. 31, 2024. The disclosures of which are hereby incorporated by reference in their entireties.

### STATEMENT REGARDING PRIOR DISCLOSURES BY THE INVENTOR OR A JOINT INVENTOR

At least one inventor or joint inventor of the present disclosure has made related disclosures in a research paper (IEEE INTERNET OF THINGS JOURNAL, VOL. 11, NO. 14, 15 Jul. 2024) on Jul. 15, 2024, which was included in the information disclosure statement submitted with this application.

### TECHNICAL FIELD

The present disclosure relates to a home energy management system and a bidirectional real-time price prediction method for demand response.

### BACKGROUND ART

Recently, advancements in Internet of Things (IoT) technology and smart metering infrastructure have enabled smart home users to schedule real-time (RT) electricity consumption through home energy management systems (HEMS, hereinafter referred to as HEMS). The electricity consumption scheduling performed by such HEMS is referred to as residential demand response (DR), which is an effective method of altering power demand by adjusting shiftable and controllable loads. Price-based DR has been regarded as a promising means of shifting users' peak loads, and a reasonable electricity pricing mechanism can directly influence customers' ability to participate in DR. To implement price-based DR, real-time pricing (RTP, hereinafter referred to as RTP) has been proven to be an effective pricing mechanism for reducing electricity bills through load shifting and mitigating peak loads on the power grid.

Although prior art by Wang, Paranjape, and others demonstrated that RTP can reduce peak-period loads and electricity costs, it was also revealed that rebound peaks may occur in other time slots, potentially increasing the peak-to-average ratio (PAR). To address this issue, Anees and Chen proposed integrating a sloped block rate with RTP to set consumption thresholds for users, thereby reducing both electricity costs and PAR. The sloped block rate has also been used to manage PAR, flatten power consumption, and improve social welfare for customers.

However, these conventional approaches face limitations, as the residential sector is complex and involves various appliances operating across different time slots. As a result, they struggle to accommodate the diverse electricity demands of end-users, and because they are not directly tied to actual prices, they may lead to inefficient behavioral changes and offer less flexible services.

In consideration of these limitations, more recent strategies have been proposed, such as customized rebate package-based pricing mechanisms for virtual power plants, fairness-aware distributed RTP frameworks, and hybrid pricing mechanisms that simultaneously account for RTP and real-time incentives.

Despite significant efforts in prior research to develop new pricing mechanisms that offer monetary incentives to encourage customer participation in DR, existing mechanisms tend to provide uniform energy pricing levels for specific user groups or regions. Although such mechanisms may influence consumer energy consumption patterns to some extent, they fall short in guiding users toward long-term and sustainable energy usage behaviors. This shortcoming arises because even when consumers are affected by RTP, their consumption behaviors are not effectively reflected in the electricity pricing. As a result, the unidirectional nature of current electricity pricing mechanisms may reduce consumer motivation to participate in residential DR. Therefore, to promote active consumer participation in residential DR, there is a need to develop a new personalized bidirectional pricing mechanism that enables consumers to influence or “develop” their own electricity pricing through bidirectional rate setting.

### DISCLOSURE

### Technical Problem

The present disclosure is directed to providing a home energy management system and a bidirectional real-time price prediction method for demand response.

In addition, the present disclosure aims to provide a home energy management system and a bidirectional real-time price prediction method for demand response, which enable autonomous hourly electricity pricing based on the user's hourly shifted power and flexible device consumption ratio.

In addition, the present disclosure is also directed to providing a home energy management system and a bidirectional real-time price prediction method for demand response, which can optimize spatio-temporal real-time electricity prices through a deep learning-based prediction model, and schedule the operation of home appliances based on the predicted prices.

Furthermore, the present disclosure aims to provide a home energy management system and a bidirectional real-time price prediction method for demand response, which can contribute to encouraging user participation in demand response by offering incentives or penalties based on the consumer's power consumption patterns.

### Technical Solution

According to an aspect of the present disclosure, there is provided a bidirectional real-time price prediction method for demand response.

According to an embodiment of the present disclosure, there is provided a bidirectional real-time price prediction method for demand response, comprising: (a) acquiring user-related information and real-time electricity price data for a smart home user; (b) generating future electricity price prediction information by applying the user-related information and real-time electricity prices into a deep learning-based prediction model; (c) generating power consumption scheduling results for smart home devices based on the electricity price prediction information; (d) analyzing the power consumption scheduling results to calculate hourly shifted power and flexible device consumption ratio, and calculating a mobility adjustment value and a consumption adjustment value based on the hourly shifted power and flexible device consumption ratio, respectively; (e) calculating an incentive-penalty weight value according to power consumption type using the shift adjustment value and the consumption adjustment value; and (f) deriving a bidirectional real-time electricity price by reflecting the incentive-penalty weight value in the electricity price prediction information.

The deep learning-based prediction model is configured to: extract spatial features by inputting time-series data of the user-related information and the real-time electricity price into a first deep learning model, and generate the electricity price prediction information reflecting temporal patterns by applying the extracted spatial features to a second deep learning model.

The first deep learning model is based on an Unsupervised Shallow Convolutional Neural Network (USCNN), and the second deep learning model is based on a nested Long Short-Term Memory (nLSTM) architecture.

The mobility adjustment value is calculated using the following mathematical expression.

$${Δλ}_{i}^{HSP} ( t ) = \{ \begin{matrix}\frac{{λ}_{RTP} ( t ) - {λ}_{RTP}^{min}}{{\vec{F}}_{i}^{HSP , max}} {F}_{i}^{HSP} , if {X}^{HSP} > 0 ∀ t \\ \frac{{λ}_{RTP} ( t ) - {λ}_{RTP}^{max}}{{\overleftarrow{F}}_{i}^{HSP , max}} {F}_{i}^{HSP} , if {X}^{HSP} < 0 ∀ t\end{matrix}$$

where λ_{RTP(t)} represents an actual real-time electricity prices,

$$\begin{matrix}{λ}_{RTP}^{min} and \\ {λ}_{RTP}^{max}\end{matrix}$$

represent a minimum value and a maximum value of a bidirectional real-time electricity prices, X^{HSP} represents hourly shifted power values,

$$\begin{matrix}{\vec{F}}_{i}^{HSP , max} and \\ {\overleftarrow{F}}_{i}^{HSP , max}\end{matrix}$$

represent maximum credit score values of positive and negative directions, respectively.

The consumption adjustment value is calculated using the following mathematical expression.

$${Δλ}_{i}^{HFA} ( t ) = \frac{{λ}_{RTP} ( t ) - {λ}_{RTP}^{min}}{{F}_{i}^{HFA , max} - {F}_{i , 0}} [ {F}_{i}^{HFA} ( t ) - {F}_{i , 0} ] ∀ t ,$$

where λ_{RTP(t)} represents an actual real-time electricity price,

$${λ}_{RTP}^{min}$$

represents a minimum value of the bidirectional real-time electricity price,

$${F}_{i}^{HFA}$$

represents a credit score for a consumer's flexible device consumption ratio, F_{i,0} represents a default score,

$${F}_{i}^{HFA , max}$$

represents a maximum credit score based on the flexible device consumption ratio.

The user-related information includes load, device information, previous consumption patterns, and usage status of flexible devices.

The incentive-penalty weight value is calculated using the following mathematical expression.

$${Δλ}_{i} ( t ) = {δΔλ}_{i}^{HSP} ( t ) + ( 1 - δ ) {Δλ}_{i}^{HFA} ( t ) ∀ t$$

where

$${Δλ}_{i}^{HSP} ( t )$$

represents a mobility adjustment value,

$${Δλ}_{i}^{HFA} ( t )$$

represents a consumption adjustment value of a flexible device, δ represents a variation weight of the real-time electricity price.

According to another aspect of the present disclosure, a system for performing a bidirectional real-time price prediction method for demand response is provided.

According to an embodiment of the present disclosure, there is provided a home energy management system comprising: a memory configured to store at least one instruction; and a processor configured to execute the instruction stored in the memory, wherein the instruction, when executed by the processor, causes the system to perform: (a) acquiring user-related information and real-time electricity price data for a smart home user; (b) generating future electricity price prediction information by applying the user-related information and the real-time electricity price to a deep learning-based prediction model; (c) generating power consumption scheduling results for smart home devices based on the electricity price prediction information; (d) analyzing the power consumption scheduling results to calculate hourly shifted power and flexible device consumption ratio, and calculating a mobility adjustment value and a consumption adjustment value based on the hourly shifted power and flexible device consumption ratio, respectively; (e) calculating an incentive-penalty weight value corresponding to the power consumption pattern using the mobility adjustment value and the consumption adjustment value; and (f) reflecting the incentive-penalty weight value in the electricity price prediction information to derive a bidirectional real-time electricity price.

### Advantageous Effects

By providing the home energy management system and the bidirectional real-time price prediction method for demand response according to one embodiment of the present disclosure, autonomous hourly electricity pricing can be enabled using the user's hourly shifted power and flexible device consumption ratio.

In addition, the present disclosure can optimize spatio-temporal real-time electricity pricing through a deep learning-based prediction model and schedule the operation of home appliances based on the predicted prices.

Furthermore, the present disclosure offers the advantage of encouraging user participation in demand response by providing incentives or penalties according to the consumer's power consumption patterns.

### BRIEF DESCRIPTION OF THE DRAWINGS

FIG. 1 is a flowchart illustrating a bidirectional real-time price prediction method for demand response in the PHEMS according to an embodiment of the present disclosure.

FIG. 2 is a diagram showing the overall architecture of the PHEMS according to an embodiment of the present disclosure.

FIG. 3 is a diagram illustrating the segmented intervals of HSP and HFA according to an embodiment of the present disclosure.

FIG. 4 is a diagram comparing a conventional model with the first deep learning model according to an embodiment of the present disclosure.

FIG. 5 is a diagram showing the nLSTM architecture according to an embodiment of the present disclosure.

FIG. 6 is a diagram showing pseudocode for the bidirectional real-time price prediction method for demand response in the PHEMS according to an embodiment of the present disclosure.

FIG. 7 is a diagram illustrating the power consumption decision timeline according to an embodiment of the present disclosure.

FIG. 8 is a block diagram schematically illustrating the internal configuration of the home energy management system according to an embodiment of the present disclosure.

### BEST MODE

In the present specification, singular forms include plural forms unless the context clearly indicates otherwise. In the specification, the terms “composed of” or “include,” and the like, should not be construed as necessarily including all of several components or several steps described in the specification, and it should be construed that some component or some steps among them may not be included or additional components or steps may be further included. In addition, the terms “ . . . unit’, “module”, and the like disclosed in the specification refer to a processing unit of at least one function or operation and this may be implemented by hardware or software or a combination of hardware and software.

Hereinafter, the embodiments of the present disclosure will be described in detail with reference to the accompanying drawings.

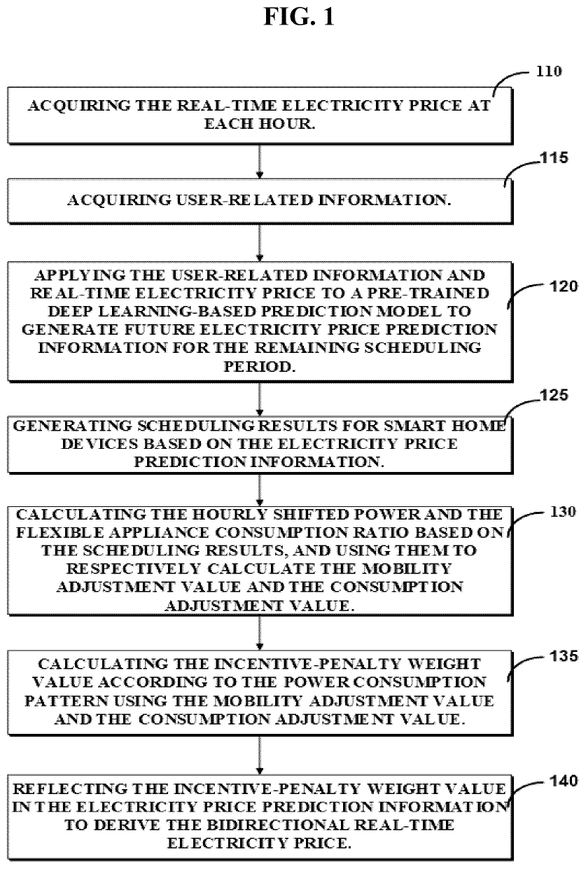

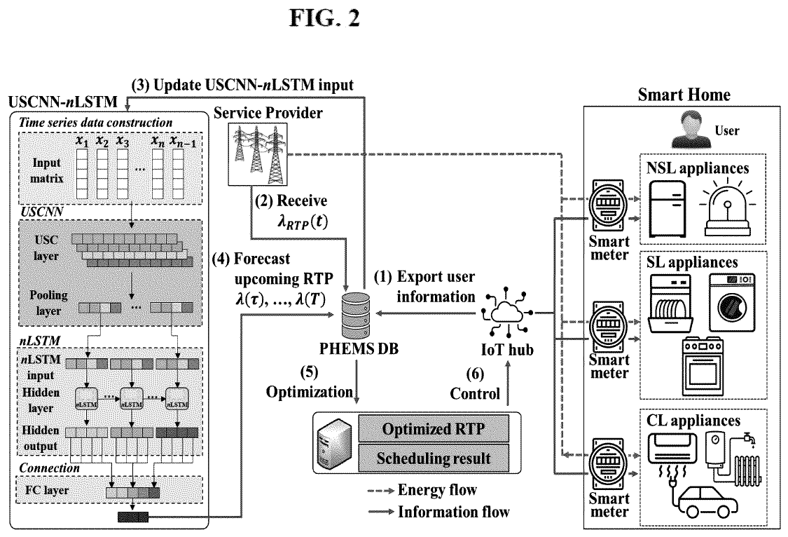

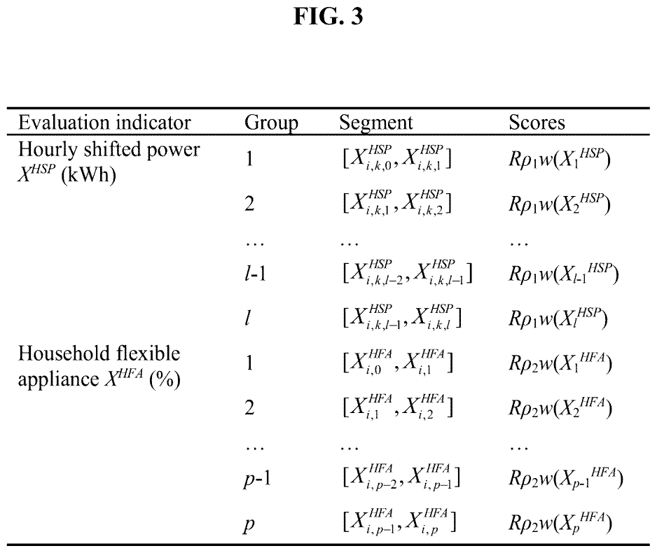

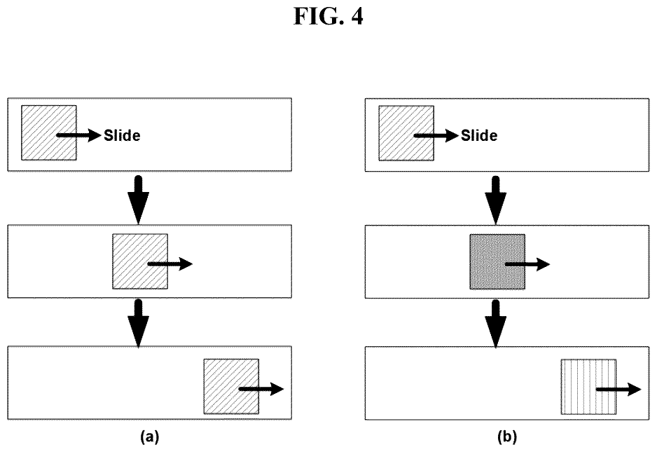

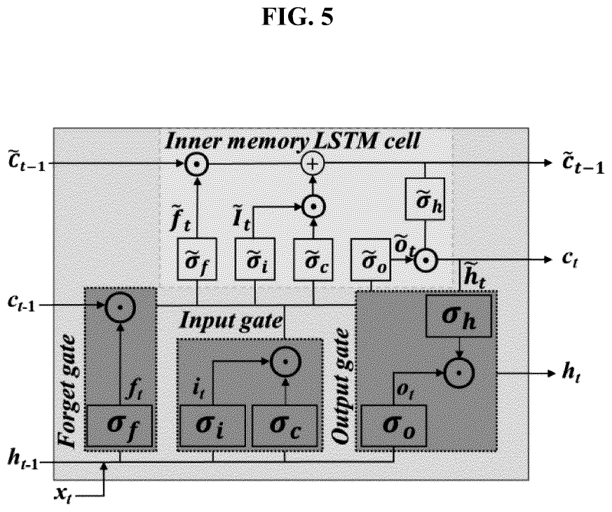

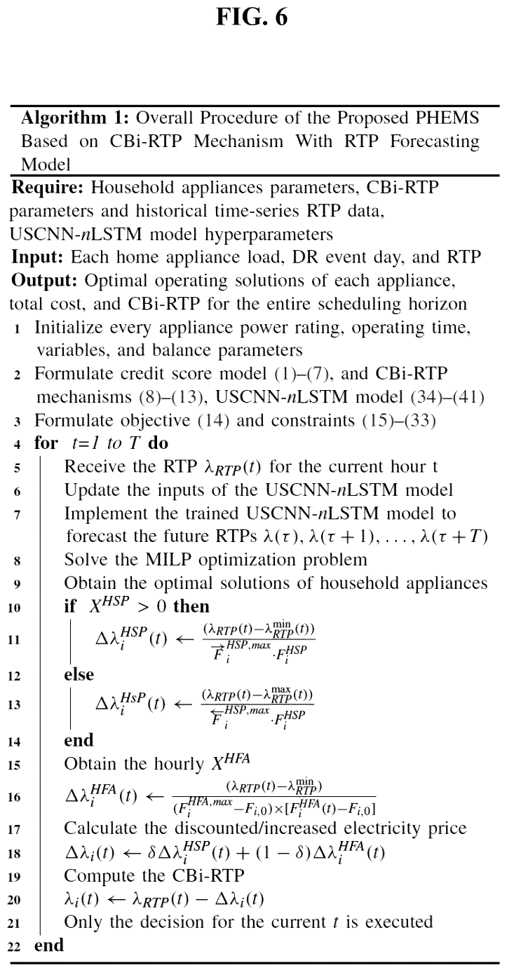

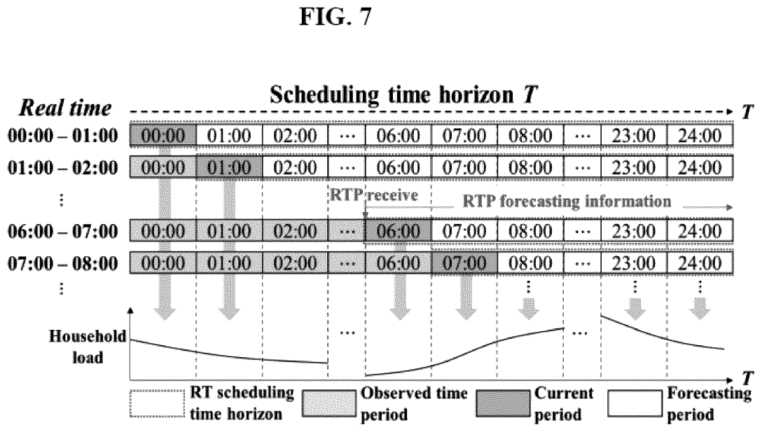

FIG. 1 is a flowchart illustrating a bidirectional real-time price prediction method for demand response in the PHEMS according to an embodiment of the present disclosure, FIG. 2 is a diagram showing the overall architecture of the PHEMS according to an embodiment of the present disclosure, FIG. 3 is a diagram illustrating the segmented intervals of HSP and HFA according to an embodiment of the present disclosure, FIG. 4 is a diagram comparing a conventional model with the first deep learning model according to an embodiment of the present disclosure, FIG. 5 is a diagram showing the nLSTM architecture according to an embodiment of the present disclosure, FIG. 6 is a diagram showing pseudocode for the bidirectional real-time price prediction method for demand response in the PHEMS according to an embodiment of the present disclosure, FIG. 7 is a diagram illustrating the power consumption decision timeline according to an embodiment of the present disclosure.

In step 110, the PHEMS acquires the real-time electricity price at each hour.

For example, the PHEMS may acquire the real-time electricity price (RTP) from the utility company server on an hourly basis.

In step 115, the PHEMS acquires user-related information, which may include load, device information, previous consumption patterns, and the usage status of flexible devices.

FIG. 2 illustrates the overall architecture of the PHEMS. A brief explanation will be provided with reference to FIG. 2.

According to one embodiment of the present disclosure, as illustrated in FIG. 2, the PHEMS is described under the assumption that a smart meter and an IoT hub are installed within the smart home (residence), enabling the user to record data and control the power of home appliances.

According to one embodiment of the present disclosure, the PHEMS may analyze user-related information such as the load of each smart home, hourly shifted power (HSP), and household flexible appliance (HFA) consumption ratio to predict future real-time electricity prices (RTP). Additionally, weather information and the like may also be included as part of the user-related information.

To this end, the PHEMS is linked with the IoT hub and can acquire user-related information (e.g., load information of devices) updated through the IoT hub in real time. Using this information, the PHEMS can reflect the contribution to changes in power consumption and peak load reduction in future RTP prediction. This will be more clearly understood from the following description.

According to one embodiment of the present disclosure, the PHEMS may analyze the hourly shifted power and the flexible appliance consumption ratio, respectively, in order to determine the degree and capability of demand response by smart home users.

Amore detailed explanation is provided as follows.

As illustrated in FIG. 2, household appliances may include shifted load (SL) devices, non-shiftable load (NSL) devices, and control load (CL) devices.

The hourly shifted power (HSP) represents the difference in power consumption before and after demand response. When the load at a given time(t) exceeds the average hourly power demand, it may be regarded as a peak time (tₚ). However, if the load at a given time (t) is below the average hourly power demand, it is designated as a valley time. Here, the valley time refers to the opposite of the peak time-indicating periods of reduced power consumption and relatively lower electricity prices.

Accordingly, the HSP of the i-th consumer at time t on day k can be expressed as shown in Equation 1.

$${X}_{i , k}^{HSP} ( t ) = \{ \begin{matrix}{D}^{BDR} ( t ) - {D}^{ADR} ( t ) , & t ∈ {t}_{p} \\ {D}^{ADR} ( t ) - {D}^{BDR} ( t ) , & t ∈ {t}_{v}\end{matrix} \qquad [ Equation 1 ]$$

Here, D^{BDR}(t) and Dₜ^{ADR}(t) represent the consumer demand before and after demand response, respectively. Although consumers are encouraged to shift energy consumption from peak times to valley times, actual energy consumption may unexpectedly increase.

Accordingly,

$${X}_{i , k}^{HSP} ( t )$$

may be represented as a positive or negative value. For user i, a discrete ordered list set of

$${X}_{i , k}^{HSP} ( t )$$

values can be obtained by arranging the energy consumption values over day k in ascending order. This set can then be divided into specific intervals to calculate credit scores, as illustrated in FIG. 3.

In general, among household appliances, flexible devices can be classified into shifted load (SL) devices, non-shiftable load (NSL) devices, and control load (CL) devices. SL devices include dishwashers and washing machines, while NSL devices may include refrigerators and lighting equipment. Electric vehicles and home energy storage systems can be considered as flexible devices.

X^{HFA} can be defined as the ratio of energy consumed by flexible devices to the total power consumption of all household appliances. As this ratio increases, the structure of the user's appliance usage can be considered more optimized. Similar to X^{HSP}, X^{HFA} can also be divided into specific intervals, as illustrated in FIG. 3.

The weight of evidence (WOE) method is used to analyze the responsiveness and capability of end-users in household demand response (DR). Each user's credit score is calculated based on WOE, which can have a direct impact on the user's real-time pricing signal, either positively or negatively.

The binary variable φ indicates whether the selected evaluation index affects the household's power consumption behavior. If φ=1, it means that the index influences power consumption behavior.

The logistic regression representing the relationship between p{φ=1|X}can be expressed as Equation 2, where Xᵢ={X^{HSP}, X^{HFA}}.

$$p ( φ = 1 ) = \frac{1}{1 + {e}^{- ( α + {ρ}_{1} {X}^{HSP} + {ρ}_{2} {X}^{HFA} )}} \qquad [ Equation 2 ]$$

$$ln ( \frac{p}{1 - p} ) = α + {ρ}_{1} {X}^{HSP} + {ρ}_{2} {X}^{HFA} \qquad [ Equation 3 ]$$

$$w ( {x}_{pq} ) = ln \frac{p ( φ = 1 \vert {X}_{p} = {x}_{pq} )}{p ( φ = 0 \vert {X}_{p} = {x}_{pq} )} \qquad [ Equation 4 ]$$

Here, α, ρ₁ and ρ₂ represent the parameters of the regression model. In addition, p(φ=1) indicates the probability that the consumer's energy behavior change is correlated with the evaluation indices Xᵢ={X^{HSP}, X^{HFA}}. Equation 2 can be transformed into Equation 3. To improve the standardization of different types of indicators, the impact of each value of a specific attribute variable on the classification result can be calculated using Equation 4.

p(φ=1|Xₚ=X_{pq}) and p(Y=OXp=X_{pq}) represent the probabilities that the sample belongs to category φ=1 and φ=⁰, respectively, given the attribute variable Xₚ=X_{pq}. As the WOE increases, both the probability and the weight for φ=1 may increase. Based on the optimal partial outcomes of the evaluation indices Xᵢ={X^{HsP}, X^{HFA}}, the WOE transformation of Xᵢ can be expressed as shown in Equation 5.

$$WOE ( {X}_{i} ) = {μ}_{1} w ( {X}_{1}^{HSP} ) + {μ}_{2} w ( {X}_{2}^{HSP} ) + ⋯ + {μ}_{m} w ( {X}_{m}^{HSP} ) + {γ}_{1} w ( {X}_{1}^{HFA} ) + {γ}_{2} w ( {X}_{2}^{HFA} ) + ⋯ + {γ}_{n} w ( {X}_{n}^{HFA} ) \qquad [ Equation 5 ]$$

Here, μₘ and γₙ represent virtual binary variables, where μₘ=1 or γₙ=1 if the value of Xᵢ belongs to the m-th or n-th category, respectively. Accordingly, after the WOE transformation, Equation 3 can be expressed as Equation 6.

$$ln ( \frac{p}{1 - p} ) = α + {ρ}_{1} {μ}_{1} w ( {X}_{1}^{HSP} ) + {ρ}_{2} {μ}_{2} w ( {X}_{2}^{HSP} ) + ⋯ {ρ}_{1} {μ}_{m} w ( {X}_{m}^{HTP} ) {ρ}_{2} {γ}_{1} w ( {X}_{1}^{HFA} ) {ρ}_{2} {γ}_{2} w ( {X}_{1}^{HFA} ) + ⋯ + {ρ}_{2} {γ}_{n} w ( {X}_{n}^{HFA} ) \qquad [ Equation 6 ]$$

To intuitively predict the performance of end-users in demand response (DR), the capability of Equation 6 can be enhanced by transforming it into a linear representation of the ratio logarithm, as shown in Equation 7.

$$F ( t ) = {F}_{base} + R ln ( \frac{p}{1 - p} ) \qquad [ Equation 7 ]$$

Here, F_{base} and R represent constants calculated using known score values, either by assigning an exact score expected at a specific ratio or by adopting a method that doubles the score based on the ratio. These methods can utilize the average credit score within the interval [Xₘ₋₁, Xₘ] to enhance the practicality and applicability of the credit score model. By identifying the specific interval to which the value of the evaluation index belongs, an appropriate score corresponding to that interval can be determined.

In step 120, the PHEMS applies the user-related information and real-time electricity price to a pre-trained deep learning-based prediction model to generate future electricity price prediction information for the remaining scheduling period.

In step 125, the PHEMS may generate scheduling results for smart home devices based on the electricity price prediction information.

In step 130, the PHEMS calculates the hourly shifted power and the flexible appliance consumption ratio based on the scheduling results, and uses these to respectively calculate the mobility adjustment value and the consumption adjustment value.

In step 135, the PHEMS calculates the incentive-penalty weight value based on the power consumption pattern using the mobility adjustment value and the consumption adjustment value.

In step 140, the PHEMS reflects the incentive-penalty weight value in the electricity price prediction information to derive the bidirectional real-time electricity price.

As described above, the PHEMS can generate future electricity price prediction information for the remaining scheduling period using the user-related information and real-time electricity price updated hourly, and based on this, solve an optimization problem to execute optimal scheduling of home appliances.

For the sake of clarity and ease of understanding, the formulation of the optimization problem will be explained first.

Amore detailed explanation is provided as follows.

The bidirectional real-time electricity price (hereinafter referred to as CBi-RTP) can provide positive incentives for efficient power usage by smart home users, while imposing penalties for excessive consumption. As a result, the higher the HFA of a smart home user, the lower their actual electricity bill, thereby encouraging users to proactively improve their appliance configuration.

The CBi-RTP based on the evaluation model can be expressed as shown in Equation 8.

$${λ}_{i} ( t ) = {λ}_{RTP} ( t ) - {Δλ}_{i} ( t ) ∀ t \qquad [ Equation 8 ]$$

$${λ}_{RTP}^{min} \leq {λ}_{i} ( t ) \leq {λ}_{RTP}^{max} ∀ t \qquad [ Equation 9 ]$$

Here, λᵢ(t) represents the CBi-RTP after optimization by the PHEMS, and λ_{RTP}(t) denotes the actual RTP.

$${λ}_{RTP}^{min} and {λ}_{RTP}^{max}$$

represent the minimum and maximum values of λᵢ(t), respectively. In addition, Δλᵢ(t) indicates the incentive-penalty weight based on the user's power consumption behavior. For example, if Δλᵢ(t) is positive, it functions as an incentive, whereas if it is negative, it may act as a penalty. Hereinafter, the term “incentive or penalty” should be understood as referring to the incentive-penalty weight. The discounted or increased RTP for user i at time t is defined in Equation 10 and can be reformulated as shown in Equation 11.

$${Δλ}_{i} ( t ) = {δΔλ}_{i}^{HSP} ( t ) + ( 1 - δ ) {Δλ}_{i}^{HFA} ( t ) ∀ t \qquad [ Equation 10 ]$$

$${Δλ}_{i} ( t ) = {δθ}_{i}^{HSP} ( t ) {F}_{i}^{HSP} + ( 1 - δ ) {θ}_{i}^{HFA} ( t ) [ {F}_{i}^{HFA} - {F}_{i , 0} ] ∀ t \qquad [ Equation 11 ]$$

Here,

$${θ}_{i}^{HSP} and {θ}_{i}^{HFA}$$

and represent the RTP variation coefficients for user i with respect to HSP and HFA, respectively.

$${F}_{i}^{HSP} and {F}_{i}^{HFA}$$

and denote the credit scores of user i for HSP and HFA, respectively. δ indicates the RTP variation weight, and F_{i,0} represents the base score considering the initial score of user i. In the case of X^{HSP}, positive incentives or negative penalties can alter consumption behavior to reduce peak load periods, thereby decreasing the CBi-RTP for power consumption. This serves to encourage the end user to regulate their consumption.

$${Δλ}_{i}^{HSP} ( t ) = \{ \begin{matrix}\frac{{λ}_{RTP} ( t ) - {λ}_{RTP}^{min}}{{\vec{F}}_{i}^{HSP , max}} {F}_{i}^{HSP} , & if {X}^{HSP} > 0 ∀ t \\ \frac{{λ}_{RTP} ( t ) - {λ}_{RTP}^{max}}{{\overleftarrow{F}}_{i}^{HSP , max}} {F}_{i}^{HSP} , & if {X}^{HSP} < 0 ∀ t\end{matrix} \qquad [ Equation 12 ]$$

Here,

$${\vec{F}}_{i}^{HSP , max} and {\overleftarrow{F}}_{i}^{HSP , min}$$

represent the maximum credit score values in the positive and negative directions, respectively. If X^{HSP}>0, the obtained

$${Δλ}_{i}^{HSP} ( t )$$

indicates a positive value, which can lead to a decrease in (t).

Similarly, the CBi-RTP variation caused by X^{HFA} can be expressed as shown in Equation 13, where

$${F}_{i}^{HFA , max}$$

represents the maximum credit score for HFA.

$${Δλ}_{i}^{HFA} ( t ) = \frac{{λ}_{RTP} ( t ) - {λ}_{RTP}^{min}}{{F}_{i}^{HFA , max} - {F}_{i , 0}} [ {F}_{i}^{HFA} ( t ) - {F}_{i , 0} ] ∀ t . \qquad [ Equation 13 ]$$

The objective of the smart home application is to minimize the electricity consumption cost of the smart home over the entire time horizon while ensuring user convenience, taking into account SL, NSL, and CL devices.

As previously described, the home appliances within the smart home can be classified into three categories: SLs (shifted loads), NSLs (non-shiftable loads), and CLs (control loads).

SLs refer to devices such as dishwashers, washing machines, and ovens, which can be scheduled to operate during off-peak hours to reduce hourly electricity rates and lower overall electricity costs. These SL devices can have binary operating states of “on” and “off.”

NSLs include devices such as refrigerators and lighting, whose demand is non-adjustable and must be met at all times.

CLs refer to devices such as air conditioners (AC), electric water heaters (EWH), and plug-in electric vehicles (PEVs), which can operate flexibly within a predefined energy consumption range and thus have continuous variables.

The objective of residential smart home applications is to minimize the electricity consumption cost of the smart home over the entire time horizon while ensuring user comfort, taking into account SL, NSL, and CL devices.

Accordingly, the objective function of the PHEMS can be expressed as shown in Equation 14.

$$min {\sum }_{a = 1}^{A} {\sum }_{b = 1}^{B} {\sum }_{c = 1}^{C} \{ \begin{matrix}{\sum }_{t} λ ( t ) ( {d}_{a}^{SL} ( t ) + {d}_{b}^{NSL} ( t ) + {d}_{c}^{CL} ( t ) ) + \\ {\sum }_{τ = t + 1}^{T} λ ( τ ) ( {d}_{a}^{SL} ( τ ) + {d}_{b}^{NSL} ( τ ) + {d}_{c}^{CL} ( τ ) )\end{matrix} \} \qquad [ Equation 14 ]$$

Here,

$${d}_{a}^{SL} ( t ) , {d}_{n}^{NSL} ( t ) , and {d}_{c}^{CL} ( t )$$

represent the power demand of SL, NSL, and CL devices, respectively, indicating the power consumption at time t for the a-th, b-th, and c-th device. The first part of Equation 14 represents the cost incurred in the current time slot according to the CBi-RTP X(t), while the second part denotes the aggregated cost over future time slots, considering the predicted future prices based on the proposed USCNN-nLSTM model.

The constraints for these home appliances are as follows:

Constraints for SL devices: The operational constraints for SL devices such as washing machines, dishwashers, and electric ovens can be expressed as shown in Equations 15 through 17.

$$\begin{matrix}{\prod }_{k = 1}^{{k}_{a}} {X}_{a}^{SL} ( t + k - 1 ) = 1 ∀ i , a , t , k & ∀ t > 0\end{matrix} \qquad [ Equation 15 ]$$

$${T}_{a}^{so} \leq {T}_{a}^{wb} \leq [ {T}_{a}^{end} - {T}_{a}^{re} ] \qquad [ Equation 16 ]$$

$${T}_{a}^{re} \leq {T}_{a}^{end} - {T}_{a}^{so} \qquad [ Equation 17 ]$$

Here, a represents a general schedulable device, where a=1, 2, . . . , Nₐ.

$${T}_{a}^{end} and {T}_{a}^{re}$$

denote the deadline by which the SL device must complete its operation and the duration required for its operation, respectively. If a schedulable device is planned to start operating at time t, the task will continue without interruption until the end of its kₐ-step operation cycle (as expressed in Equation 15). The constraints in Equations 16 and 17 restrict the start time and the required duration, respectively. Finally, the total demand of the SL devices is expressed as shown in Equation 18.

$${d}_{a}^{SL} ( t ) = {P}_{a}^{SL} ( t ) {X}_{a}^{SL} ( t ) ∀ a , t \qquad [ Equation 18 ]$$

Here,

$${X}_{a}^{SL} ( t ) \{ 0 , 1 \} ,$$

where 1 indicates that the device is operating at time t, and 0 otherwise

$${P}_{a}^{SL} ( t )$$

represents the power consumption of the household device.

Constraints for CL devices: In contrast to SLs, CL devices such as air conditioners (AC), electric water heaters (EWH), and plug-in electric vehicles (PEVs) can flexibly consume energy within a predefined range between the minimum and maximum demand levels. This can be expressed as shown in Equation 19.

$${d}_{b}^{CL , min} \leq {d}_{b}^{CL} ( t ) \leq {d}_{b}^{CL , max} ∀ b , t \qquad [ Equation 19 ]$$

Here,

$${d}_{b}^{CL , min}$$

represents the minimum energy consumption of the b-th CL device. In particular, according to one embodiment of the present disclosure, indoor temperature and hot water temperature are considered-two critical factors that affect user comfort in the home, especially through the power regulation of the AC and EWH.

Controlling indoor temperature using the AC is one of the most significant loads in a household, as it directly impacts the comfort of the occupants. The variable operation of the AC can be applied to reduce operational costs by leveraging the physical property of thermal inertia in the smart home structure. This can be expressed as shown in Equation 20.

$$[ Equation 20 ]$$

$${T}_{in}^{AC} ( t + 1 ) = {T}_{in}^{AC} ( t ) + \frac{( {T}_{out}^{AC} ( t ) - {T}_{in}^{AC} ( t ) ) Δ T}{1000 {M}_{a} {c}_{a} {R}^{eq}} - \frac{COP \cdot {P}^{AC} Δ T}{0.000277 {M}_{a} {c}_{a}} {X}^{AC} ( t ) ∀ t > 0$$

Here,

$${T}_{inset}^{AC} ( t ) and {T}_{inset}^{AC} ( t )$$

represent the indoor and outdoor temperatures at time t, respectively, and X^{AC}(t) indicates the operating status of the AC—where 1 means the AC is operating, and 0 means it is not. Mₐ, cₐ, and R^{eq} represent the mass of indoor air, the specific heat capacity of air, and the equivalent thermal resistance of the house, respectively.

Additionally, P^{AC} denotes the power consumption of the AC. The indoor temperature at each time point can be calculated using Equation 20. This formulation is designed for cooling but can be easily modified to model heating operation of the AC.

Additionally, the operating status of the AC, X^{AC}(t), is influenced by the current indoor temperature relative to a predefined acceptable indoor temperature range, which can be expressed as shown in Equation 21.

$${T}^{AC} ( t ) = \{ \begin{matrix}{T}^{AC} ( t - 1 ) , & {\underline{T}}_{inset}^{AC} \leq {T}_{in}^{AC} ( t ) \leq {\overline{T}}_{inset}^{AC} \\ 1 , & {T}_{in}^{AC} ( t ) > {\overline{T}}_{inset}^{AC} \\ 0 , & {T}_{in}^{AC} ( t ) < {\underline{T}}_{inset}^{AC}\end{matrix} ∀ t > 0 \qquad [ Equation 21 ]$$

$${\underline{T}}_{inset}^{AC} \leq {T}_{in}^{AC} ( t ) \leq {\overline{T}}_{inset}^{AC} ∀ t \qquad [ Equation 22 ]$$

Here,

$${\underline{T}}_{inset}^{AC} and {\overline{T}}_{inset}^{AC}$$

represent the lower and upper bounds of the indoor temperature, respectively. Accordingly, Equation 18 can be reformulated as Equation 22.

During the operation of the EWH, the principle of energy conservation is applied. After the use of hot water, the water tank temperature at time t can be expressed as shown in Equation 23.

$${T}_{in}^{EWH} ( t ) = \frac{{V}^{tank} - {V}^{use} ( t )}{{V}^{tank}} ( {T}_{in}^{EWH} ( t ) - {T}_{inlet} ) + {T}_{inlet} ∀ t > 0 \qquad [ Equation 23 ]$$

Here,

$${\hat{T}}_{in}^{EWH} ( t ) , {T}_{in}^{EWH} ( t ) , {V}^{tank} , {V}^{use} ( t ) ,$$

and Tᵢₙₗₑₜ represent the temperature after hot water usage, the water temperature at time t, the volume of the water tank, the amount of hot water used, and the inlet water temperature, respectively. In Equation 23, the temperature of cold water is used as a reference point and is assumed to have zero energy.

When the EWH operates at its rated power, the water tank temperature after heating at time t can be expressed as shown in Equation 24.

$${T}_{in}^{EWH} ( t ) - {T}_{in}^{EWH} ( t - 1 ) + 3600 \frac{{X}^{EWH} ( t ) {P}^{EWH} Δ T}{{C}_{w} {M}_{w}} ∀ t > 0 \qquad [ Equation 24 ]$$

Here, X^{EWH}(t) represents the operating status of the EWH at time t, where 1 indicates that it is operating and 0 indicates it is not. C_{w} denotes the specific heat capacity of water, and M_{w} refers to the mass of water when the EWH is full. Finally, the operating status of the EWH can be influenced by the current water temperature and the upper and lower bounds of the EWH temperature, which can be expressed as shown in Equation 25.

$${X}^{EWH} ( t ) = \{ \begin{matrix}{X}^{EWH} ( t - 1 ) , & {\underline{T}}_{inset}^{EWH} \leq {\hat{T}}_{in}^{EWH} \leq {\overline{T}}_{inset}^{EWH} \\ 1 , & {T}_{in}^{EWH} ( t ) > {\overline{T}}_{inset}^{EWH} \\ 0 , & {T}_{in}^{EWH} ( t ) < {\underline{T}}_{inset}^{EWH}\end{matrix} ∀ t > 0 \qquad [ Equation 25 ]$$

$${\underline{T}}_{inset}^{EWH} \leq {\hat{T}}_{in}^{EWH} \leq {\overline{T}}_{inset}^{EWH} \qquad [ Equation 26 ]$$

Here,

$${\underline{T}}_{inset}^{EWH} and {\overline{T}}_{inset}^{EWH}$$

represent the lower and upper bounds of the acceptable water temperature, respectively. Based on this, Equation 18 for the EWH can be reformulated as Equation 26.

The PEV is considered a CL device in the PHEMS and can contribute to improving scheduling performance in the smart home and reducing electricity costs. To predict the plug-in power of the PEV, the influence of the driving distance can be modeled as shown in Equation 27, and the battery constraints can be represented as shown in Equation 28.

$${E}_{in}^{PEV} = \{ \begin{matrix}{\underline{E}}^{PEV} , & if {E}_{out}^{PEV} - {E}_{cc} \times d \leq {\underline{E}}^{PEV} \\ {E}_{out}^{PEV} - {E}_{cc} \times d , & otherwise\end{matrix} \qquad [ Equation 27 ]$$

$$\underline{SOE} \leq {SOE}^{PEV} \leq \overline{SOE} \qquad [ Equation 28 ]$$

Here,

$${E}_{in}^{PEV} , {\underline{E}}^{PEV} and {E}_{out}^{PEV}$$

represent the energy of the PEV at the time of plug-in, the minimum required energy, and the energy at plug-out, respectively. E_{CC} refers to the battery energy consumption per kilometer, set at 0.159 kWh/km. SOE and S̅O̅E̅ represent the minimum and maximum state of charge of the PEV battery, respectively. Given

$${E}_{out}^{PEV}$$

and driving distance d, the amount of

$${E}_{in}^{PEV}$$

can be calculated using Equation 27. However, in practice, the value of

$${E}_{out}^{PEV}$$

is known, while

$${E}_{in}^{PEV}$$

and d are not. Therefore, the conditional probability of

$${E}_{in}^{PEV}$$

given

$${E}_{out}^{PEV}$$

can be derived as shown in Equation 29.

$${M}_{{A}_{2} {B}_{2}} = Pr ( {E}_{in}^{PEV} = {A}_{2} \vert {E}_{out}^{PEV} = {B}_{2} ) \qquad [ Equation 29 ]$$

Here, M_{A}_{₂}_{B}_{₂} represents the conditional probability that the PEV battery energy at plugged-in time is

$${E}_{in}^{PEV} = {A}_{2}$$

and results in

$${E}_{in}^{PEV} = {A}_{2} .$$

Accordingly, the daily dynamics of the PEV can be expressed as shown in Equation 30.

$${E}^{PEV} ( t + 1 ) = \{ \begin{matrix}{E}^{PEV} ( t ) , & if {X}^{PEV} ( t ) = 0 , {X}^{PEV} ( t + 1 ) = 0 \\ {Pr [ {E}_{in}^{PEV} ]}_{{\underline{p}}^{PEV}}^{{\overline{p}}^{PEV}} & if {X}^{PEV} ( t ) = 0 , {X}^{PEV} ( t + 1 ) = 1 \\ {E}^{PEV} ( t ) + Δ t ( {P}^{PEV} ( t ) - η \vert {P}^{PEV} ( t ) \vert ) , & if {X}^{PEV} ( t ) = 1\end{matrix} \qquad [ Equation 30 ]$$

Here P^{PEV}(t), P̅^{PEV}, P^{PEV} and η represent the power of the PEV, maximum and minimum charging/discharging power of the PEV, and the efficiency of the PEV P^{PEV}(t) can take either a positive or negative value, indicating charging or discharging, respectively. Finally, the daily power consumption of CL appliances, considering the AC, EWH, and PEV, can be expressed as shown in Equation 31.

$${d}_{c}^{CL} ( t ) = {P}_{c}^{AC} ( t ) {X}_{c}^{AC} ( t ) + {P}_{c}^{EWH} ( t ) {X}_{c}^{EWH} ( t ) + {P}_{c}^{PEV} ( t ) {X}_{c}^{PEV} ( t ) ∀ c , t . \qquad [ Equation 31 ]$$

Additionally, according to one embodiment of the present disclosure, since the CBi-RTP price is based on the RTP, it must remain within a reasonable price range to enhance applicability.

Therefore, the CBi-RTP constraint can be expressed as shown in Equation 32.

$${λ}_{RTP}^{min} \leq {λ}_{i} ( t ) \leq {λ}_{RTP}^{max} ∀ t . \qquad [ Equation 32 ]$$

In a smart home, the power balance constraint must be ensured. This power balance constraint can be expressed as shown in Equation 33.

$${P}^{Grid} ( t ) = {P}^{SL} ( t ) X ( t ) + {P}^{NSL} ( t ) X ( t ) + {P}^{CL} ( t ) X ( t ) . \qquad [ Equation 33 ]$$

Here, P^{Grid}(t) represents the amount of power purchased from or sold to the grid at time t to ensure power consumption is balanced.

According to one embodiment of the present disclosure, energy cost information can be provided to the consumer one hour in advance, enabling the management of power consumption across various smart home appliances with different features. To achieve this, whenever the current real-time electricity price (RTP) is provided, a deep learning model can be used to predict future RTP. Accordingly, the prediction of future RTP can be performed repeatedly every hour as the real-time electricity price is updated.

To this end, a description of the deep learning model is provided below.

A convolutional neural network (hereinafter referred to as CNN) is widely adopted for price prediction, as it can effectively capture the interrelationship between RTP and its specific structural patterns and extract more significant features. However, traditional CNNs are prone to overfitting and gradient vanishing problems due to the large number of parameters. In addition, CNNs assume that the spatial features of the input data are invariant, whereas RTP in reality exhibits spatial variability.

Accordingly, in one embodiment of the present disclosure, to address the aforementioned issues, a first deep learning model based on an unsupervised shallow convolutional neural network (USCNN) is employed to enhance data feature quality and improve RTP prediction accuracy. The USCNN consists of an Unshared Convolution (USC) layer, a pooling layer, and a fully connected layer, with the USC layer being the core component. Let the input be X∈ [symbol] ^{W×F} and the output be Y∈ [symbol] ^{(W-K+1)×F}. Here, W, K, and F represent the window length, kernel size, and number of features, respectively. Thus, the USCNN model can be expressed as shown in Equation 34.

$${y}_{i , j} = {\sum }_{a = j}^{j + K - 1} {x}_{i , a} {h}_{i , a} [ a - j ] + {b}_{ij} , \qquad [ Equation 34 ]$$

Here, y_{i,j} and b_{i,j} represent the element at row i, column j, and the bias matrices, respectively, while x_{i,a} and h_{i,a} denote the input element and the weight at row i, column a. The weights h cannot be shared because the weight matrix h_{i,a} changes depending on the values of i and j. FIG. 4 illustrates the difference between a conventional CNN and a USCNN. The large bounding boxes represent feature maps, and the small squares represent convolution kernels sliding over the map to extract features. The black arrows indicate the convolution steps of the kernel sliding at different positions. In FIG. 4(a), kernels shown in the same color indicate shared weight parameters, while in FIG. 4(b), the USC kernels are shown with different patterns, indicating that their weight parameters are not shared. Since the USCNN model cannot extract temporal features, the deep learning model according to one embodiment of the present disclosure further employs a second deep learning model—namely, an nLSTM (non-stationary Long Short-Term Memory)—to learn temporal features.

According to one embodiment of the present disclosure, the first deep learning model (USCNN) receives as input user-related information and real-time electricity prices, structured as time-series data, and extracts spatial features from them.

The second deep learning model (nLSTM) analyzes the spatial features extracted by the first model and is capable of identifying periodic changes and RTP patterns from historical data.

The LSTM model is an improved network of the recurrent neural network (RNN) based on additional memory units to overcome the gradient vanishing or exploding problem and has been widely employed for time-series forecasting, such as load, solar, wind, and price forecasting. Since the price value has distinct time-series features, strong time evolution patterns, and long-term dependencies, LSTM can be adopted to mine the rules of time-series variation in the obtained data set. In the LSTM, the memory and gate cells can effectively recognize and capture long-term dependencies in the target sequence. Generally, an LSTM network comprises a series of LSTMs, which are stacked one after another, where the output of each layer is treated as the input of the subsequent layer.

In one embodiment of the present disclosure, a nested LSTM (nLSTM) model is employed to effectively address the issue of temporal variability and to allow selective access to internal memory when generating the temporal hierarchy of RTP. In nLSTM, instead of stacking layers, memory functions are nested within one another, allowing the architecture to be easily extended into a deeper structure.

FIG. 5 is a diagram illustrating the structure of the second deep learning model (nLSTM) according to one embodiment of the present disclosure. As shown in FIG. 5, the value of a memory cell in the nLSTM is calculated using the LSTM architecture, which acts as an internal unit for its own memory cells. Subsequently, the long-term information trained by the internal unit can be selectively learned and transferred using conventional LSTM gates. This mechanism enables the internal memory to learn and process events such as sudden price spikes over the long term, which is particularly useful when such events are not directly related to the immediate present. The internal update equations for nLSTM are provided in Equations 35 through 41.

$$\tilde{{i}_{t}} = \tilde{σ} ( {\tilde{W}}_{xi} {\tilde{x}}_{t} + {\tilde{W}}_{hi} {\tilde{h}}_{t} - 1 + {\tilde{W}}_{ci} {\tilde{c}}_{t} - 1 + {\tilde{b}}_{i} ) \qquad [ Equation 35 ]$$

$${\tilde{f}}_{t} = \tilde{σ} ( {\tilde{W}}_{x} f {\tilde{x}}_{t} + {\tilde{W}}_{hf} {\tilde{h}}_{t} - 1 + {\tilde{W}}_{cf} {\tilde{c}}_{t} - 1 + {\tilde{b}}_{f} ) \qquad [ Equation 36 ]$$

$${\tilde{c}}_{t} = {\tilde{f}}_{i} ⊙ {\tilde{c}}_{t - 1} + {\tilde{i}}_{t} ⊙ {\tilde{σ}}_{c} ( {\tilde{W}}_{xc} {\tilde{x}}_{t} + {\tilde{W}}_{hc} {\tilde{h}}_{t - 1} + {\tilde{b}}_{c} ) \qquad [ Equation 37 ]$$

$${\tilde{o}}_{t} = {\tilde{σ}}_{o} ( {\tilde{W}}_{xo} {\tilde{x}}_{t} + {\tilde{W}}_{ho} {\tilde{h}}_{t} - 1 + {\tilde{W}}_{co} {\tilde{c}}_{t} - 1 + {\tilde{b}}_{i} ) \qquad [ Equation 38 ]$$

$${\tilde{h}}_{t} = {\tilde{o}}_{t} ⊙ {\tilde{σ}}_{h} ( {\tilde{c}}_{t} ) \qquad [ Equation 39 ]$$

$${\tilde{x}}_{t} = {i}_{t} ⊙ {σ}_{c} ( {x}_{t} {W}_{xc} + {h}_{t - 1} {W}_{hc} + {b}_{c} ) \qquad [ Equation 40 ]$$

$${\tilde{h}}_{t - 1} = {f}_{t} ⊙ {c}_{t - 1} \qquad [ Equation 41 ]$$

Here, ĩₜ, fₜ, \tilde{c}ₜ, õₜ, and hₜ represent the input gate state, forget gate state, memory cell, output, and hidden state, respectively. xₜ, σ, W, and b denote the input, sigmoid activation function, weight matrix, and bias vector, respectively. The temporal features of RTP can be iteratively computed based on the nLSTM, allowing for effective modeling of time-dependent price dynamics.

In summary, the PHEMS receives the real-time electricity price (RTP) at each time t, updates the user-related information (e.g., power demand) as input to the deep learning model, and generates future RTP (electricity price prediction information) for the remaining scheduling period using a previously trained deep learning model. Subsequently, based on the predicted RTP, the PHEMS generates scheduling results by making optimal decisions that satisfy the objective function for home appliances. The scheduling results can be represented as

$$d = [ {d}_{a}^{SL} , {\underline{d}}_{b}^{NSL} , {d}_{c}^{CL} ] ,$$

where

$${d}_{a}^{SL} , {d}_{b}^{NSL}$$

are discrete variables and

$${d}_{c}^{CL}$$

is a continuous variable operating within a predefined range. The HSP and HFA values of a smart home user are divided into specific intervals, and corresponding credit scores can be assigned based on these intervals. Then, a discounted or increased RTP is calculated, and a customized CBi-RTP tailored to the specific user can be derived.

According to one embodiment of the present disclosure, as illustrated in FIG. 7, the PHEMS performs optimization at each time t to obtain power consumption decisions for the current and remaining time slots. However, only the decision for the current hour is implemented for household loads, which provides the smart home with optimal energy management instructions for the current slot. Through this iterative process, the PHEMS is made robust against price uncertainty and ensures dynamic adjustment of control policies and self-correction of the model as new information is received and operating conditions change. In addition, by enabling consumers to engage in formulating the electricity prices, the proposed pricing mechanism can improve household users' enthusiasm for participating in residential DR, with significantly improved economic benefits. The overall pseudocode for this process is illustrated in FIG. 6.

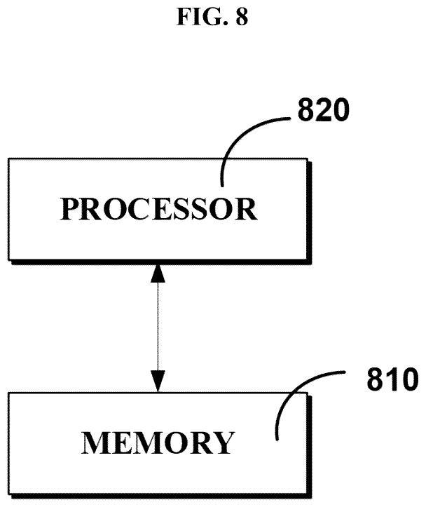

FIG. 8 is a block diagram schematically illustrating the internal configuration of a home energy management system according to one embodiment of the present disclosure.

Referring to FIG. 8, the home energy management system according to the embodiment of the present disclosure includes a memory (810) and a processor (820).

The memory (810) stores at least one instruction for performing the bidirectional real-time price prediction method for demand response according to one embodiment of the present disclosure.

The processor (820) can execute the instructions stored in the memory (810). The instructions executed by the processor (820) perform a series of operations including: receiving the real-time electricity price (RTP) at each time t, updating user-related information (e.g., power demand) as input to the deep learning model, generating future RTP (electricity price prediction information) for the remaining scheduling period using a pre-trained deep learning model, producing scheduling results by making optimal decisions that satisfy the objective function for home appliances based on the predicted RTP, calculating the hourly shifted power and the flexible appliance consumption ratio based on the scheduling results, computing the mobility adjustment value and consumption adjustment value based on the calculated metrics, calculating the incentive-penalty weight based on power consumption patterns using the above adjustment values, reflecting the calculated weight in the electricity price prediction information to derive the bidirectional real-time electricity price.

This process corresponds to the descriptions provided with reference to FIGS. 1 through 7, and thus redundant explanations are omitted.

The apparatus and the method according to the embodiment of the present disclosure may be implemented in a form of program commands that may be executed through various computer means and may be recorded in a computer-readable recording medium. The computer-readable recording medium may include a program command, a data file, a data structure, or the like, alone or in a combination thereof. The program commands recorded in the computer-readable recording medium may be especially designed and constituted for the present disclosure or be known to and usable by those skilled in a field of computer software. Examples of the computer-readable recording medium may include magnetic media such as a hard disk, a floppy disk, and a magnetic tape; optical media such as a compact disk read only memory (CD-ROM) or a digital versatile disk (DVD); magneto-optical media such as a floptical disk; and a hardware device specially configured to store and execute program commands, such as a ROM, a random access memory (RAM), a flash memory, or the like. Examples of the program commands include a high-level language code capable of being executed by a computer using an interpreter, or the like, as well as a machine language code made by a compiler.

The above-mentioned hardware device may be constituted to be operated as one or more software modules in order to perform an operation according to the present disclosure, and vice versa.

Hereinabove, the present disclosure has been described with reference to exemplary embodiments thereof. It will be understood by those skilled in the art to which the present disclosure pertains that the present disclosure may be implemented in a modified form without departing from essential features of the present disclosure. Therefore, the exemplary embodiments disclosed herein should be considered in an illustrative aspect rather than a restrictive aspect. The scope of the present disclosure should be defined by the claims rather than the above-mentioned description, and all differences within the scope equivalent to the claims should be interpreted to fall within the present disclosure.

What is claimed is:

1. A bidirectional real-time price prediction method for demand response, comprising:
(a) acquiring user-related information and real-time electricity price for a smart home user;
(b) generating future electricity price prediction information by applying the user-related information and the real-time electricity price to a deep learning-based prediction model;
(c) generating power consumption scheduling results for smart home devices based on the electricity price prediction information;
(d) analyzing the power consumption scheduling results to calculate hourly shifted power and flexible device consumption ratio, and calculating a mobility adjustment value and a consumption adjustment value based on the hourly shifted power and flexible device consumption ratio, respectively;
(e) calculating an incentive-penalty weight value corresponding to a power consumption pattern using the mobility adjustment value and the consumption adjustment value; and
(f) reflecting the incentive-penalty weight value in the electricity price prediction information to derive a bidirectional real-time electricity price.

2. The bidirectional real-time price prediction method for demand response according to claim 1,
wherein the deep learning-based prediction model is configured to: extract spatial features by inputting time-series data of the user-related information and the real-time electricity price into a first deep learning model, and generate the electricity price prediction information reflecting temporal patterns by applying the extracted spatial features to a second deep learning model.

3. The bidirectional real-time price prediction method for demand response according to claim 2,
wherein the first deep learning model is based on an Unsupervised Shallow Convolutional Neural Network (USCNN), and
the second deep learning model is based on a nested Long Short-Term Memory (nLSTM) architecture.

4. The bidirectional real-time price prediction method for demand response according to claim 1,
wherein the mobility adjustment value is calculated using the following mathematical expression.
$${Δλ}_{i}^{HSP} ( t ) = \{ \begin{matrix}\frac{{λ}_{RTP} ( t ) - {λ}_{RTP}^{min}}{{\vec{F}}_{i}^{HSP , max}} {F}_{i}^{HSP} , if {X}^{HSP} > 0 ∀ t \\ \frac{{λ}_{RTP} ( t ) - {λ}_{RTP}^{max}}{{\vec{F}}_{i}^{HSP , max}} {F}_{i}^{HSP} , if {X}^{HSP} < 0 ∀ t\end{matrix}$$
where λ_{RTP(t)} represents the real-time electricity price,
$${λ}_{RTP}^{min} and {λ}_{RTP}^{max}$$
represent a minimum value and a maximum value of the bidirectional real-time electricity price, X^{HSP} represents hourly shifted power values,
$${\vec{F}}_{i}^{HSP , max} and {\overleftarrow{F}}_{i}^{HSP , max}$$
represent maximum credit score values of positive and negative directions, respectively.

5. The bidirectional real-time price prediction method for demand response according to claim 1,
wherein the consumption adjustment value is calculated using the following mathematical expression.
$${Δλ}_{i}^{HFA} ( t ) = \frac{{λ}_{RTP} ( t ) - {λ}_{RTP}^{min}}{{F}_{i}^{HFA , max} - {F}_{i , 0}} [ {F}_{i}^{HFA} ( t ) - {F}_{i , 0} ] ∀ t .$$
where λ_{RTP(t)} represents the real-time electricity price,
$${λ}_{RTP}^{min}$$
represents a minimum value of the bidirectional real-time electricity price,
$${F}_{i}^{HFA}$$
represents a credit score for a consumer's flexible device consumption ratio, F_{i,0} represents a default score,
$${F}_{i}^{HFA , max}$$
represents a maximum credit score based on the flexible device consumption ratio.

6. The bidirectional real-time price prediction method for demand response according to claim 1,
wherein the user-related information includes load, device information, previous consumption patterns, and usage status of flexible devices.

7. The bidirectional real-time price prediction method for demand response according to claim 1,
wherein the incentive-penalty weight value is calculated using the following mathematical expression.
$${Δλ}_{i} ( t ) = {δΔλ}_{i}^{HSP} ( t ) + ( 1 - δ ) {Δλ}_{i}^{HFA} ( t ) ∀ t$$
where
$${Δλ}_{i}^{HSP} ( t )$$
represents the mobility adjustment value,
$${Δλ}_{i}^{HFA} ( t )$$
represents the consumption adjustment value of a flexible device, δ represents a variation weight of the real-time electricity price.

8. A non-transitory computer-readable recording medium having recorded thereon a program code for performing the method according to claim 1.

9. A home energy management system comprising:
a memory configured to store at least one instruction; and
a processor configured to execute the instruction stored in the memory,
wherein the instruction, when executed by the processor, causes the system to perform:
(a) acquiring user-related information and real-time electricity price for a smart home user;
(b) generating future electricity price prediction information by applying the user-related information and the real-time electricity price to a deep learning-based prediction model;
(c) generating power consumption scheduling results for smart home devices based on the electricity price prediction information;
(d) analyzing the power consumption scheduling results to calculate hourly shifted power and flexible device consumption ratio, and calculating a mobility adjustment value and a consumption adjustment value based on the hourly shifted power and flexible device consumption ratio, respectively;
(e) calculating an incentive-penalty weight value corresponding to a power consumption pattern using the mobility adjustment value and the consumption adjustment value; and
(f) reflecting the incentive-penalty weight value in the electricity price prediction information to derive a bidirectional real-time electricity price.

10. The home energy management system according to claim 9,
wherein the deep learning-based prediction model is configured to: extract spatial features by inputting time-series data of the user-related information and the real-time electricity price into a first deep learning model, and generate the electricity price prediction information reflecting temporal patterns by applying the extracted spatial features to a second deep learning model.

11. The home energy management system according to claim 10,
wherein the first deep learning model is based on an Unsupervised Shallow Convolutional Neural Network (USCNN), and
the second deep learning model is based on a nested Long Short-Term Memory (nLSTM) architecture.

12. The home energy management system according to claim 9,
wherein the mobility adjustment value is calculated using the following mathematical expression.
$${Δλ}_{i}^{HSP} ( t ) = \{ \begin{matrix}\frac{{λ}_{RTP} ( t ) - {λ}_{RTP}^{min}}{{\vec{F}}_{i}^{HSP , max}} {F}_{i}^{HSP} , & if {X}^{HSP} > 0 ∀ t \\ \frac{{λ}_{RTP} ( t ) - {λ}_{RTP}^{minax}}{{\overleftarrow{F}}_{i}^{HFA , max}} {F}_{i}^{HSP} , & if {X}^{HSP} < 0 ∀ t\end{matrix}$$
where λ_{RTP(t)} represents the real-time electricity price,
$${λ}_{RTP}^{min} and {λ}_{RTP}^{max}$$
represent a minimum value and a maximum value of the bidirectional real-time electricity price, X^{HSP} represents hourly shifted power values,
$${\vec{F}}_{i}^{HSP , max} and {\overleftarrow{F}}_{i}^{HSP , max} .$$
represent maximum credit score values of positive and negative directions, respectively.

13. The home energy management system according to claim 9,
wherein the consumption adjustment value is calculated using the following mathematical expression.
$${Δλ}_{i}^{HFA} ( t ) = \frac{{λ}_{RTP} ( t ) - {λ}_{RTP}^{min}}{{F}_{i}^{HFA , max} - {F}_{i , 0}} [ {F}_{i}^{HFA} ( t ) - {F}_{i , 0} ] ∀ t .$$
where λ_{RTP(t)} represents the real-time electricity price,
$${λ}_{RTP}^{min}$$
represents a minimum value of the bidirectional real-time electricity price,
$${F}_{i}^{HFA}$$
represents a credit score for a consumer's flexible device consumption ratio, F_{i,0} represents a default score,
$${F}_{i}^{HFA , max}$$
represents a maximum credit score based on the flexible device consumption ratio.

14. The home energy management system according to claim 9,
wherein the incentive-penalty weight value is calculated using the following mathematical expression.
$$Δ {λ}_{i} ( t ) = {δΔλ}_{i}^{HSP} ( t ) + ( 1 - δ ) {Δλ}_{i}^{HFA} ( t ) ∀ t$$
where
$${Δλ}_{i}^{HSP} ( t )$$
represents the mobility adjustment value,
$${Δλ}_{i}^{HFA} ( t )$$
represents the consumption adjustment value of a flexible device, δ represents a variation weight of the real-time electricity price.
